(19) United States
(12) Patent Application Publication
(10) Pub. No.: US 2026/0225328 A1
(43) Pub. Date: Aug. 6, 2026

(54) FORMING TABLE

(71) Applicant: Tusas- Turk Havacilik Ve Uzay Sanayii Anonim Sirketi, Kahramankazan, Ankara (TR)

(72) Inventors: Cagri AKIN, Kahramankazan, Ankara (TR); Turker DOLEK, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/149,913

(22) PCT Filed: Jan. 19, 2024
(86) PCT No.: PCT/TR2024/050043

§ 371 Date: Jul. 22, 2025

(30) Foreign Application Priority Data
Jan. 23, 2023 (TR) 2023/000770

(51) Int. Cl. B29C 70/30; B29C 53/04; B29C 53/82; B29C 53/84; B29L 31/30; B64F 5/10

(52) U.S. Cl. CPC B29C 70/30; B29C 53/04; B29C 53/82; B29C 53/84; B64F 5/10; B29L 2031/3079

(57) ABSTRACT

The present invention relates to a body (2), a base (Z) on which the body (2) is positioned, a material (3) placed on the body (2) to be subjected to a forming process, a mandrel (4) on the body (2), giving the material (3) its shape, and a frame (5) holding the material (3) on the mandrel (4).

This invention relates to tables on which canopy materials in air vehicles are shaped.

In aircraft canopies, transparent polymer materials with a lighter structure are generally used instead of glass. Giving shape to materials such as acrylic and polycarbonate used in the manufacture of canopy is usually done by vacuum molding methods. However, in the vacuum forming process, the material thickness changes uncontrollably. The light refractions occurring in the polymer material are not at an acceptable level in today's aircraft (especially fighter aircraft). Various forming methods are used to keep the thickness constant in the forming process.

The European patent document EP0882566, which is included in the known state of the art, describes an adjustable clamping frame for a forming station of a thermoforming machine, wherein heated thermoplastic plates are deformed by means of a mold via differential pressure according to their type. There is a closed box in the upper part in which are placed a stationary clamping frame that clamps the plate as well as a height-adjustable upper frame, wherein the forming station can be continuously adjusted by inserting molded parts of different sizes.

The United States patent document U.S. Pat. No. 5,026,514, which is included in the known state of the art, describes a conveyor system for the heating and forming processes of a layer to be formed. The layer to be formed is moved after being attached to rails.

Thanks to a forming table developed by this invention, it is ensured that canopies used in aircraft are produced efficiently without subjecting the thickness thereof to variation.

Another object of the present invention is to enable all operations to be carried out on one table for the easier forming of canopies of air vehicles.

A further object of the present invention is to provide low-cost canopy forming using a single table in the production of canopies of different sizes and shapes.

The forming table realized to achieve the object of the invention, defined in the first claim and in the claims dependent on this claim, comprises a body positioned on a base, a material positioned on the body to be subjected to a forming process, a mandrel from which the material takes its shape, and a frame that holds the material together with the mandrel on the body.

The forming table of the invention comprises at least two arms that constitute the frame, which are located on the body so as to be rotated around the axis to which they are connected, and which are positioned mutually so that the material and mandrel can be positioned in between them. There is a first position (I) in which the arms extend parallel to the ground, and a second position (II) in which the material takes the shape of the mandrel when the arms are brought as a result of being bent around the axis to which they are connected. There is at least one holder located between the mutually positioned arms, holding the material from at least one throughout edge thereof and ensuring the continuation of the shape of the material. There are at least one rod that comes into contact with the holder when the arms come from the first position (I) to the second position (II) by being bent around the axes at which they are connected to the body, gives the throughout edge shape to the material by holding it from its edge and enables the holder to be fixed, as well as a part obtained by heating and forming the material.

In an embodiment of the invention, the forming table comprises a part that is converted from a crystalline atomic structure to an irregular atomic (amorphous) structure as a result of heating, produced from a transparent acrylic thermoplastic material, brought from the first position (I) to the second position (II) on the body by being subjected to heating and brought to a solid form by lowering the temperature of the material below the glassy transition temperature.

In an embodiment of the invention, the forming table comprises a part in the form of an air vehicle canopy, having a transparent and lightweight structure that can transmit light and preventing a change in the view angle of pilots during flight.

In an embodiment of the invention, the forming table comprises a holder made of spring steel, having a flexible structure such that it can almost take the shape of the rod with a curved structure in line with the desired edge form of the canopy when the arms are brought to the second position (II), and taking the shape of the rod and enabling the material to have the same edge form.

In an embodiment of the invention, the forming table comprises at least one joint that enables the arms to be brought from the first position (I) to the second position (II) by being rotated around the axis at which they are connected to the body. There are arms which bent so as to enable the material to be stretched when each of them are rotated in different directions around the joint to which they are connected.

In an embodiment of the invention, the forming table comprises a channel forming a throughout longitudinal opening so as to provide the linear movement of the holder when it is slid from the inside of the arms. The channel ensures that the edges of the material are longitudinally in line with respect to each other with a precise tolerance. There is an apparatus that enables the position adjustment when the user slides the holder through the channel, thereby stretching and shaping the material.

In an embodiment of the invention, the forming table comprises at least one locking mechanism that prevents the linear movement of the apparatus on the channel and enables the material to be stretched during the transition from the first position (I) to the second position (II) while remaining stationary on the arms.

In an embodiment of the invention, the forming table comprises at least one actuator that enables the arms to be rotated around the joint and be brought from the first position (I) to the second position (II) once triggered by the user.

In an embodiment of the invention, the forming table comprises at least one pulley fixed to the body, being able to change the direction of the force applied to it by rotating around its own axis, at least one elastic element on the actuator connected to the arms, surrounding the pulley all around and enabling the arms to be moved via the pulley as a result of being subjected to an applied force at one end thereof, a trigger in the form of a weight, the pulley enabling the arms to be brought from the first position (I) to the second position (II) with the arms being rotated around the joint when the trigger is connected to the elastic element.

In an embodiment of the invention, the forming table comprises a body, being heated in a furnace as a heat source and enabling the material to stay at a user-predetermined temperature during the forming process during which the part takes its final form after being brought from the first position (I) to the second position (II).

The forming table realized to achieve the object of the present invention is shown in the attached figures, wherein from these figures;

FIG. 1 is a perspective view of the forming table in the first position (I).

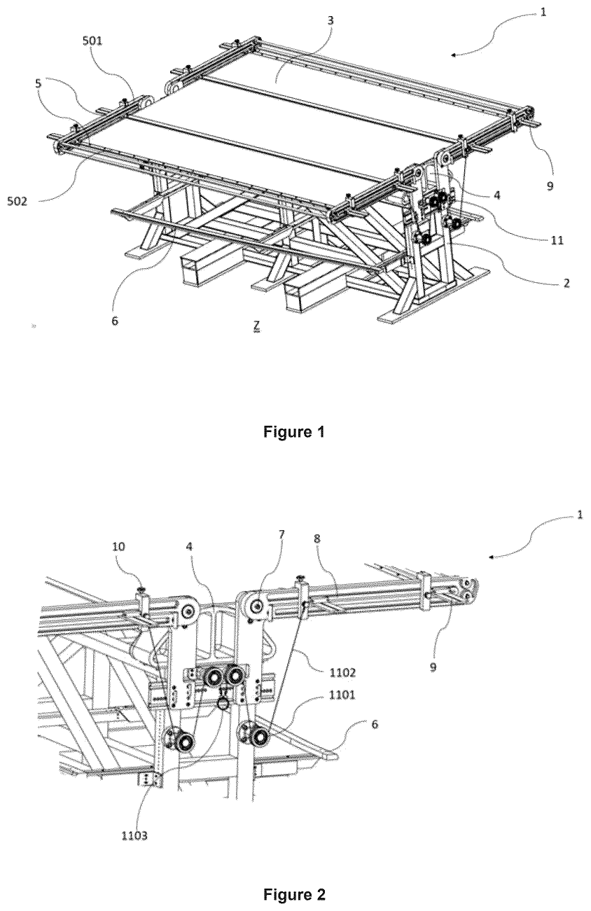

FIG. 2 is a side view of the forming table in the first position (I).

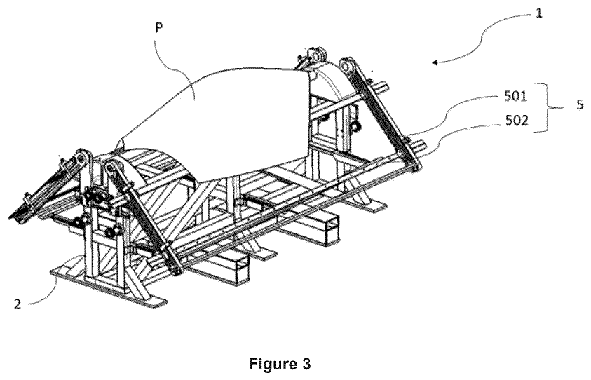

FIG. 3 is a perspective view of the forming table in the second position (II).

The parts illustrated in figures are individually assigned a reference numeral and the corresponding terms of these numerals are listed below.
1. Forming table
2. Body
3. Material
4. Mandrel
5. Frame
   501. Arm
   502. Holder
6. Rod
7. Joint
8. Channel
9. Apparatus
10. Lock mechanism
11. Actuator
   1101. Pulley
   1102. Elastic element
   1103. Trigger
I. First position
II. Second position
P. Part
Z. Base

The forming table (1) comprises a body (2), a base (Z) on which the body (2) is located, a material (3) that is placed on the body (2) to be subjected to a forming process, a mandrel (4) on the body (2), that gives its shape to the material (3), and a frame (5) that holds the material (3) on the mandrel (4).

The forming table (1) of the invention comprises at least two arms (501) constituting the frame (5), being located on the body (2) so as to be rotated around the axis to which they are connected, and being positioned mutually so that the material (3) and the mandrel (4) can be positioned in between them, a first position (I) in which the arms (501) extend parallel to the base (Z), a second position (II) in which the material (3) takes almost the shape of the mandrel (4) when the arms (501) are brought as a result of being bent, at least one holder (502) extending between the mutual arms (501), holding the material (3) from at least one throughout edge thereof and ensuring the continuation of the form of the material (3), at least one rod (6) that is located on the body (2), coming into contact with the holder (502) when the arms (501) come from the first position (I) to the second position (II) by being bent, taking almost the shape of the holder (502) that gives the edge shape to the material (3) and enabling the holder to be fixed, as well as a part (P) produced by subjecting the material (3) to heat treatment.

The body (2) used to shape the canopies used in aircraft is placed on the base (Z). The material (3) that will take the shape of a canopy and the mandrel (4) that will give the curved form of the canopy are also positioned on top of each other on the body (2). A frame (5) holds the material (3) and enables it to be positioned on the mandrel (4).

The material (3) and the mandrel (4) are located between at least two arms (501) which are positioned mutually in the frame (5). The arms (501) can rotate around the axis at which they are connected on the body (2). In a first position (I), the arms (501) are located parallel to the base (Z). In a second position (II), the material (3) which is bent by the rotation of the arms (501) about the axis at which they are connected to the body (2), takes almost the complete shape of the mandrel (4). The at least one holder (502) extending between the mutually located arms (501) forming the frame (5) holds the material (3) along at least one edge thereof. Thus, the continuity of the form of the material (3) is ensured by the holder (502). The at least one rod (6) is provided on the body (2), coming into a contact with the holder (502) holding the material (3) when the arms (501) come from the first position (I) to the second position (II) by being bent, fixing the holder and giving the edge shape to the material (3) to be subjected to forming. Thus, a part (P) forming the canopy is obtained as a result of the heat forming of the material (3). (FIG. 1, FIG. 3)

In an embodiment of the invention, the forming table (1) comprises a part (P) that is manufactured from a thermoplastic material (3) converted from a regular structure to a glassy structure by means of heat, and brought to a solid form by cooling down the material (3) which is brought from the first position (I) to the second position (II) on the body (2) by being subjected to heating. The structure of the material (3) is produced from acrylic thermoplastic material, which transforms from a regular structure to a glassy structure by means of heat. Thus, the material (3) can be easily shaped. When the material (3) is in the first position (I), it is ensured that it rises above the glassy transition temperature by supplying heat. The part (P) solidifies and is formed accordingly as a result of lowering the heat of the material (3), which is heated on the body (2) and brought to the second position (II), below the glassy transition temperature. Thus, the part (P) forming the canopy can be shaped.

In an embodiment of the invention, the forming table (1) comprises a transparent part (P) used as a canopy on an air vehicle. A lighter canopy is obtained thanks to the part (P) obtained from the transparent thermoplastic material (3).

In an embodiment of the invention, the forming table (1) comprises a holder (502) made of a flexible material such as spring steel so as to be able to take the curved shape of the rod (6) when the arms (501) are brought to the second position (II). Due to its flexible structure, it can take the form of the curved rod (6) so that the holder (502) can transfer the form of the canopy to the material (3).

In an embodiment of the invention, the forming table (1) comprises at least one joint (7) enabling the arms (501) to rotate around the axis at which they are connected to the body (2), and enabling the arms (501) to be brought from the first position (I) to the second position (II), the arms (501) enabling the material (3) to be stretched by being rotated around the joint (7) in a different direction from the other. The joint (7) enables the arms (501) both to be connected to the body (2) and enables the arms (501) to rotate around the axis at which they are connected to the body (2). Thus, the arms (501) can be bent and the material (3) can be brought from the form (I) in the first position to the form (II) in the second position and almost take the form of the mandrel (4).

In an embodiment of the invention, the forming table (1) comprises at least one channel (8) located so as to form a throughout longitudinal opening along the length of the arms (501), and by being slid there between, enabling the position of the holder (502) between the arms (501) to be adjusted by the user with a precise tolerance according to the size of the material (3), an apparatus(9) that enables the holder (502) to be slid in the channel (8) by the user, is in contact with the holder (502) and the channel (8), thereby enabling the material (3) to be stretched and shaped accordingly. The apparatus (9) located on the body (2) and being in contact with the holder (502) can be slid longitudinally inside the channel (8) located on the arms (501) such that the place of the holder (502) on the arms (501) can be adjusted with a precise tolerance. Thus, a canopy production of any size or any form is achieved on a single body (2).

In an embodiment of the invention, the forming table (1) comprises at least one lock mechanism (10) that limits the linear movement of the apparatus (9) along the channel (8), thereby enabling the material (3) to be stretched by bending the arms. The lock mechanism (10) fixes the position of the apparatus (9) on the arms (501). Thus, it is ensured that the thickness and tension of the material (3) in the first position (I) remain in a user-desired amount.

In an embodiment of the invention, the forming table (1) comprises at least one user-triggered actuator (11) that enables the arms (501) to be brought from the first position (I) to the second position (II) by moving them around the joint (7). Thus, the amount of bending of the arms (501) can be adjusted by the user.

In an embodiment of the invention, the forming table (1) comprises at least one pulley (1101) located on the body (2) in a stationary manner, changing the direction of the force by making a rotational movement around its own axis, at least one elastic element (1102), one end thereof being located on the arms (501), the other end thereof being subjected to an applied force, provided on the actuator (11), around the pulley (1101) and enabling the force applied to the end thereof to be transferred to the arms (501) through the pulley (1101), a trigger (1103) triggering the actuator (11) and connected to the elastic element (1102) by the user, the pulley (1101) enabling the arms (501) to be brought from the first position (I) to the second position (II) by enabling the arms to be rotated around the joint (7) when the trigger (1103) is connected to the elastic element (1102). The force to be applied to the arms (501) is applied with the help of a stationary pulley (1101) system. The arms (501) are bent by a trigger (1103) positioned by the user at the end of the pulley (1101) system. (FIG. 2)

In an embodiment of the invention, the forming table (1) comprises a body (2) placed in a heat source, which is a furnace, thus enabling the part (P) to remain at a user's predetermined temperature during the forming period. Thus, it is ensured that the temperature of the material (3) is kept constant so that the part (P) takes its final form during the forming process.

1- A forming table (1) comprising a body (2), a base (Z) on which the body (2) is located, a material (3) that is placed on the body (2) to be subjected to a forming process, a mandrel (4) on the body (2), that gives its shape to the material (3), and a frame (5) that holds the material (3) on the mandrel (4), wherein at least two arms (501) constituting the frame (5), being located on the body (2) so as to be rotated around the axis to which they are connected, and being positioned mutually so that the material (3) and the mandrel (4) can be positioned in between them, a first position (I) in which the arms (501) extend parallel to the base (Z), a second position (II) in which the material (3) takes almost the shape of the mandrel (4) when the arms (501) are brought as a result of being bent, at least one holder (502) extending between the mutual arms (501), holding the material (3) from at least one throughout edge thereof and ensuring the continuation of the form of the material (3), at least one rod (6) that is located on the body (2), coming into contact with the holder (502) when the arms (501) come from the first position (I) to the second position (II) by being bent, taking almost the shape of the holder (502) that gives the edge shape to the material (3) and enabling the holder to be fixed, as well as a part (P) produced by subjecting the material (3) to heat treatment.

2- The forming table (1) according to claim 1, wherein the part (P) being manufactured from a thermoplastic material (3) converted from a regular structure to a glassy structure by means of heat, and being brought to a solid form by cooling down the material (3) which is brought from the first position (I) to the second position (II) on the body (2) by being subjected to heating.

3- The forming table (1) according to claim 1, wherein the part (P) having a transparent structure for use as a canopy on an air vehicle.

4- The forming table (1) according to claim 1, wherein the holder (502) being made of a flexible material such as spring steel so as to be able to take the curved shape of the rod (6) when the arms (501) are brought to the second position (II).

5- The forming table (1) according to claim 1, wherein at least one joint (7) enabling the arms (501) to rotate around the axis at which they are connected to the body (2), and enabling the arms (501) to be brought from the first position (I) to the second position (II), the arms (501) enabling the material (3) to be stretched by being rotated around the joint (7) in a different direction from the other.

6- The forming table (1) according to claim 1, wherein at least one channel (8) that is located so as to form a throughout longitudinal opening along the length of the arms (501), and by being slid there between, enabling the position of the holder (502) between the arms (501) to be adjusted by the user with a precise tolerance according to the size of the material (3), and an apparatus (9) enabling the holder (502) to be slid in the channel (8) by the user, being in contact with the holder (502) and the channel (8), thereby enabling the material (3) to be stretched and shaped accordingly.

7- The forming table (1) according to claim 6, wherein at least one lock mechanism (10) that is limiting the linear movement of the apparatus (9) along the channel (8), thereby enabling the material (3) to be stretched by bending the arms.

8- The forming table (1) according to claim 5, wherein at least one user-triggered actuator (11) enabling the arms (501) to be brought from the first position (I) to the second position (II) by moving them around the joint (7).

9- The forming table (1) according to claim 8, wherein at least one pulley (1101) being located on the body (2) in a stationary manner, changing the direction of the force by making a rotational movement around its own axis, at least one elastic element (1102), one end thereof being located on the arms (501), the other end thereof being subjected to an applied force, provided on the actuator (11), around the pulley (1101) and enabling the force applied to the end thereof to be transferred to the arms (501) through the pulley (1101), a trigger (1103) triggering the actuator (11) and being connected to the elastic element (1102) by the user, the pulley (1101) enabling the arms (501) to be brought from the first position (I) to the second position (II) by enabling the arms to be rotated around the joint (7) when the trigger (1103) is connected to the elastic element (1102).

10- The forming table (1) according to claim 1, wherein the body (2) being placed in a heat source, which is a furnace, thus enabling the part (P) to remain at a user's predetermined temperature during the forming period.
